(19) United States
(12) Patent Application Publication
(10) Pub. No.: US 2011/0109903 A1
(43) Pub. Date: May 12, 2011

(54) Imaging Spectrometer

(75) Inventors: Kuan-Rong Lee, Hsinchu (TW); Cheng-Hao Ko, Hsinchu County (TW)

(73) Assignee: NATIONAL TSING HUA UNIVERSITY, Hsinchu (TW)

(21) Appl. No.: 12/942,421

(22) Filed: Nov. 9, 2010

Related U.S. Application Data
(60) Provisional application No. 61/259,334, filed on Nov. 9, 2009.

(51) Int. Cl. G01J 3/40

(52) U.S. Cl. 356/303; 356/305

(57) ABSTRACT

The present invention relates to an imaging device simultaneous records image and spectrum of an interested target utilizes spectral technology to acquire, process and exploit image data or spectrum data. The present invention allows for real time detection and identification of not only the traditional images but also the spectrum which shows the surface of the earth or reveals the chemical composition of the targeted tissue. The present invention includes a reflecting telescope, an imaging concave grating (ICG) system with spectrometer and a processor that performs spectral analysis on spectral data generated from the spectrometer.

### FIELD OF THE INVENTION

This invention relates to an imaging system for simultaneous recording of image and spectrum data of an image from a target.

### BACKGROUND OF THE INVENTION

Various imaging systems and techniques have been used for biological, medical, and aerospace applications. One approach involves multispectral imaging with an array detector. The array can be a charge-coupled device (CCD) or a photo-diode array.

A spectrometer is typically implemented to measure photometry with regard to radiation sources, and a grating in such spectrometer is a component for wavelength dispersing.

U.S. Pat. No. 5,550,375 provides an infrared spectroscopic sensor for gases, which consisted of a micro-structured spectrophotometer, a multi-frequency IR radiation source, and an IR radiation receiver. In many cases, the absorption occurs in much broader wavelength, from UV/Visible to near infrared (NIR), and even the far IR range. The applications of this prior spectroscopic sensor are limited to the IR range.

U.S. patent application Ser. No. 12/180,567 entitled “Optical System” provides an imaging optical system for separating the optical signal, as shown in FIG. 4, which comprises an input for receiving an optical signal, a predetermined output plane, and a diffraction grating for separating the optical signal received at the input into spectral components thereof. The grating has a diffraction surface, which is formed by a photolithography process. This optical system is commercially available through the company Horiba/JY (France).

The above-mentioned inventions of imaging system only record the image and spectrum data separately and therefore fail to display the image data and the spectrum data of the same image source simultaneously on the displays without period gap in the formation of image.

### BRIEF DESCRIPTIONS OF THE DRAWINGS

FIG. 1 is a diagram of an imaging system in accordance with the first embodiment of the present invention.

FIG. 2 is a diagram of an image system in accordance with the second embodiment of the present invention.

FIG. 3 is a diagram of an image system in accordance with the third embodiment of the present invention.

FIG. 4 shows a schematic of the Hyperspectral Imaging System (HSI) of the present invention.

FIG. 5 shows the wavelength scattering of a diffraction grating of the present invention.

FIG. 6 shows the image formation mechanism of the ICG optical system of the present invention.

FIG. 7 shows the tracing scheme of the image formation from the CCD image sensor ((F) and (F′)) of the present invention.

FIG. 8 shows a drawing of the top view of the ICG system of the present invention showing the entrance slit, the flat mirror and the imaging concave grating.

FIG. 9 shows a schematic of the demonstration setup of the ICG system of the present invention.

### SUMMARY OF THE INVENTION

According to the present invention, there is provided an image concave grating apparatus comprising:

an entrance slit component for forming a slit light from an input light passing through the entrance slit component according to a width and a length of an entrance slit; and

an image concave grating component for forming a grating spectrum having different wavelengths onto an image plane by scattering the slit light according to a wavelength of the slit light in different directions.

According to the present invention, there is provided an imaging system for simultaneous recording of image and spectrum data of an image from a target comprising:

a light source device for generating a light source image;

a light splitting device for dividing the light source image from the light source device into a first image and a second image;

a first photo sensor device for converting the first image into a first light signal or spectral signal;

an adapting lens device for regulating a focus of the second image to generating a regulating image;

a second photo sensor device for generating a first electrical spectrum signal or a second light signal comprising an image concave grating apparatus for forming a grating spectrum having different wavelengths onto an image plane by scattering the regulating image according to a wavelength of the regulating image, and a second photo sensor device for converting the grating spectrum into a second light signal.

According to the present invention, the imaging system for simultaneous recording of image and spectrum data of an image from a target further comprises a processor for performing spectral analysis on spectral data generated by the grating spectrum.

According to the present invention, preferably the processor compares the spectral data with abnormal data of an abnormal target to identify the abnormal target.

According to the present invention, the imaging system for simultaneous recording of image and spectrum data of an image from a target further comprises a display coupled to the processor, wherein the spectral data is displayed on the display as a spectral image.

According to the present invention, the imaging system for simultaneous recording of image and spectrum data of an image from a target further comprises an imaging channel coupled to an electronic imaging camera generating electronic image data, wherein the electronic image data is displayed as a standard image on the display.

According to the present invention, preferably the image data and the spectral data of the same light source image are simultaneously displayed on the display.

According to the present invention, preferably the light source device is a Ritchey-Chrétien (RC) telescope.

According to the present invention, preferably the light source device comprises an imaging channel and means for rotating the imaging channel to an input of the imaging channel with respect to an output of the image data and spectral data.

According to the present invention, preferably the light source device is an aerospace telescope for viewing an image or spectrum of an aerospace.

According to the present invention, preferably the first photo sensor device is a CCD sensor, a CMOS sensor, an indium gallium arsenide (InGaAs) sensor, a mercury cadmium telluride (HgCdTe) IR sensor or a lead selenide (PbSe) sensor.

According to the present invention, preferably the first photo sensor device comprises an image concave grating apparatus for forming a grating spectrum having different wavelengths onto an image plane by scattering the regulating image according to a wavelength of the regulating image, and a second photo sensor device for converting the grating spectrum.

According to the present invention, preferably the light source device is a detection device which is a thermal detector.

According to the present invention, preferably the thermal detector detects infrared image or infrared spectrum from the target.

According to the present invention, preferably the CCD sensor is a real-time-image CCD sensor.

According to the present invention, preferably the detection device is an endoscope.

According to the present invention, preferably the detection device is a recorder or camera.

According to the present invention, the imaging system for simultaneous recording of image and spectrum data of an image from a target is applied to various purposes in forest floor or ocean resources detections including water pollution or chemical waste.

According to the present invention, preferably the first photo sensor device detects from 100 nm to 5000 nm of the light source image.

According to the present invention, preferably the real-time-image CCD sensor identifies high resolution line.

According to the present invention, preferably the light splitting device is at least one mirror.

According to the present invention, preferably the mirror is a flat mirror.

According to the present invention, the imaging system for simultaneous recording of image and spectrum data of an image from a target further comprises a third photo sensor device which comprises a CCD sensor, a CMOS sensor, a indium gallium arsenide (InGaAs) sensor, a mercury cadmium telluride (HgCdTe) IR sensor or a lead selenide (PbSe) sensor for detecting a third image from the light source device.

According to the present invention, preferably the adapting lens device is an adaptor lens.

According to the present invention, preferably the image concave grating apparatus comprising:

an entrance slit component for forming a slit light from an input light passing through the entrance slit component according to a width and a length of an entrance slit; and

an image concave grating component for forming a grating spectrum having different wavelengths onto an image plane by scattering the slit light according to a wavelength of the slit light in different directions.

### DETAILED DESCRIPTIONS OF THE PREFERRED EMBODIMENTS

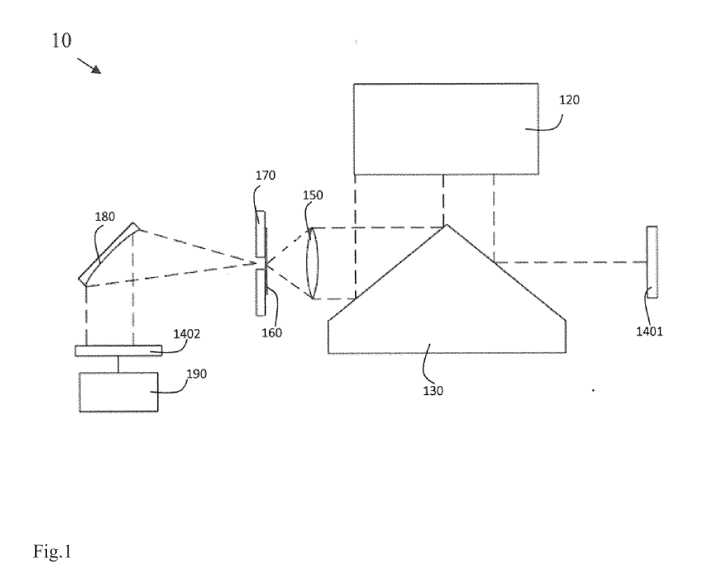

Please refer to FIG. 1 which is the FIG. 1 of this Provisional Application No. 61/259,334 showing a first embodiment of an imaging system in accordance with the invention. The imaging system 10 comprises a light source device 120 providing a light source image. A light splitting device 130 separates the light source into a first image and a second image 160. The first image on the right side is received and detected by spectral CCD sensor 1401. The second image on the left side is directed to a real-time-image Imaging-Concave-Grating (ICG) apparatus comprising an entrance slit 170 allowing the second image 160 to pass through an adaptor lens 150, an image concave grating component 180 for converting the second image 160 from the entrance slit 170 into a wide range spectrum, and a spectral CCD sensor 1402 detecting the spectrum from the image concave grating component 180. The imaging system further comprises a processor 190 for performing spectral analysis on the spectral data generated by the spectrum from the second light signal of spectral CCD sensor 1402. The imaging system preferably correlates the spectral data to spectral characteristics of an abnormal target to identify abnormal target. In a preferred embodiment, the imaging system further comprises a display coupled to the processor 190, wherein the spectral data is displayed on the display as a spectral image. In the present invention, the spectral image and the standard image of the same light source image are simultaneously displayed on the displays. In the present invention, the separation of the light source image is performed by at least one mirror 130. Preferably the mirror 130 is a flat mirror.

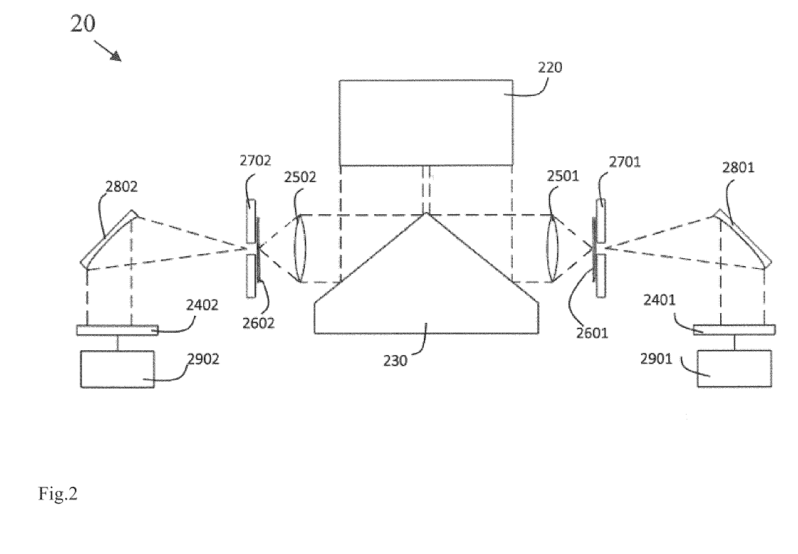

Please refer to FIG. 2 which is the FIG. 2 of this Provisional Application No. 61/259,334 showing a second embodiment of an imaging system in accordance with the invention. The imaging system 20 comprises a light source device 220 providing a light source image. A light splitting device 230 separates the light source into a first image 2601 on the right side and a second image 2602 on the left side. The first photo sensor device on the right side is the same as the second photo device on the left side. For the first photo sensor device, the first image 2601 on the right side is directed to a real-time-image Imaging-Concave-Grating (ICG) apparatus comprising an entrance slit 2701 allowing the first image 2601 to pass through an adaptor lens 2501, an image concave grating component 2801 for converting the first image 2601 from the entrance slit 2701 into a wide range spectrum, and a spectral photo sensor 2401 detecting the spectrum from the image concave grating component 2801. The imaging system further comprises a processor 2901 for performing spectral analysis on the spectral data generated by the spectrum from the second light signal of spectral photo sensor 2401 on the right side. For the second photo sensor device on the left side, the second image 2602 is directed to a real-time-image Imaging-Concave-Grating (ICG) apparatus comprising an entrance slit 2702 allowing the second image 2602 to pass through a adaptor lens 2502, an image concave grating component 2802 for converting the second image 2602 from the entrance slit 2702 into a wide range spectrum, and a spectral CCD sensor 2402 detecting the spectrum from the image concave grating component 2802. The imaging system further comprises a processor 2902 for performing spectral analysis on the spectral data generated by the spectrum from the second light signal of spectral CCD sensor 2402. The imaging system preferably correlates the spectral data to spectral characteristics of an abnormal target to identify abnormal target. In a preferred embodiment, the imaging system further comprises a display coupled to the processor 2902, wherein the spectral data is displayed on the display as a spectral image. In the present invention, the spectral image and the standard image of the same light source image are simultaneously displayed on the displays. In the present invention, the separation of the light source image is performed by at least one mirror 230. Preferably the mirror 230 is a flat mirror.

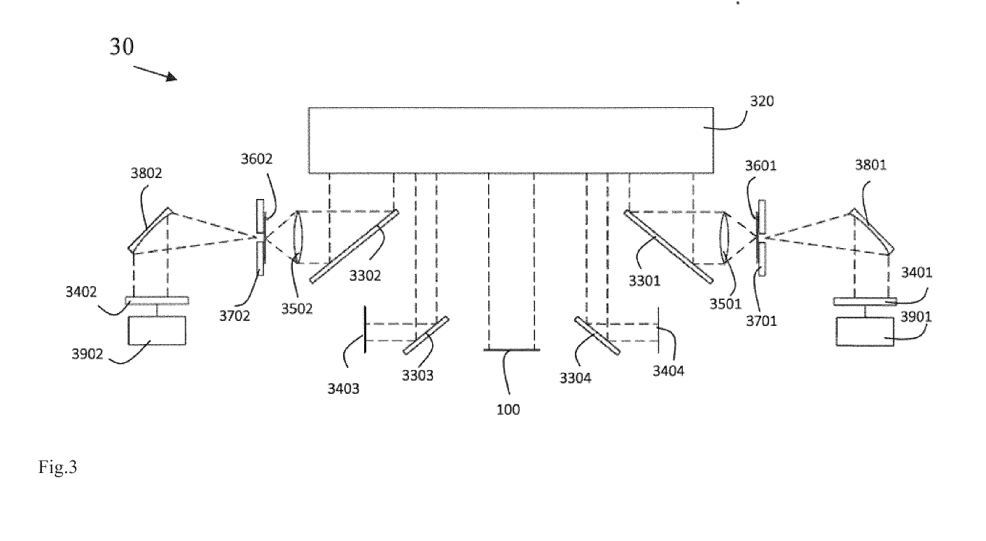

Please refer to FIG. 3 which is the FIG. 3 of this Provisional Application No. 61/259,334 showing a second embodiment of an imaging system in accordance with the invention. The imaging system 30 comprises a light source device 320 providing a light source image. Two light splitting devices 3301, 3302 separate the light source into a first image 3601 on the right side and a second image 3602 on the left side. On the right-downward side, a mirror 3304 reflects a light source image to a photo sensor 3404. On the left-downward side, a mirror 3303 reflects a light source image to a photo sensor 3403. In a downward direction, a photo sensor 100 detects a light source image from the light source 320. The first photo sensor device on the right side is the same as the second photo device on the left side. But, the photo sensors 3401, 3402, 3403, 3404, 100 may be the same or different. For the first photo sensor device, the first image on the right side is directed to a real-time-image Imaging-Concave-Grating (ICG) apparatus comprising an entrance slit 3701 allowing the first image 3601 to pass through an adaptor lens 3501, an image concave grating component 3801 for converting the first image 3601 from the entrance slit 3701 into a wide range spectrum, and a spectral photo sensor 3401 detecting the spectrum from the image concave grating component 3801. The imaging system further comprises a processor 3901 for performing spectral analysis on the spectral data generated by the spectrum from the second light signal of spectral photo sensor 3401 on the right side. For the second photo sensor device on the left side, the second image is directed to a real-time-image Imaging-Concave-Grating (ICG) apparatus comprising an entrance slit 3702 allowing the second image 3602 to pass through a adaptor lens 3501, an image concave grating component 3802 for converting the second image 3602 from the entrance slit 3702 into a wide range spectrum, and a spectral CCD sensor 3402 detecting the spectrum or the image from the image concave grating component 3802. The imaging system further comprises a processor 3902 for performing spectral analysis on the spectral data generated by the spectrum from the second light signal of spectral CCD sensor 3402. The imaging system preferably correlates the spectral data to spectral characteristics of an abnormal target to identify abnormal target. In a preferred embodiment, the imaging system further comprises a display coupled to the processor 3902, wherein the spectral data is displayed on the display as a spectral image. In the present invention, the spectral image and the standard image of the same light source image are simultaneously displayed on the displays. In the present invention, the separation of the light source image is performed by at least one mirror 3301, 3302, 3303, 3304. Preferably the mirrors 3301, 3302, 3303, 3304 flat mirrors.

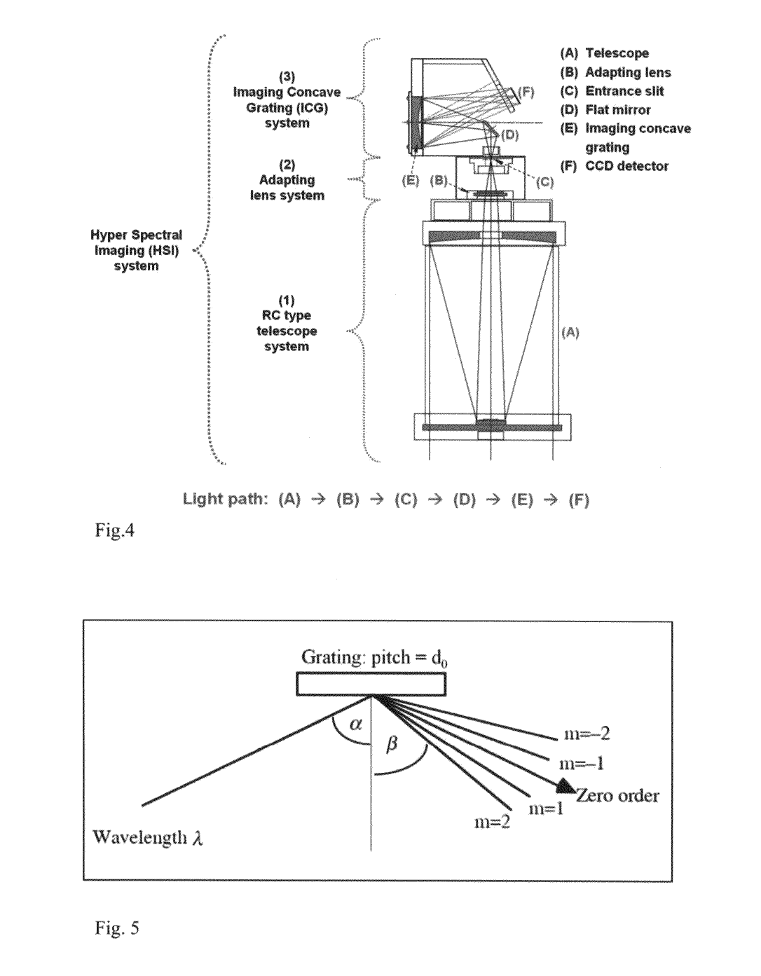

FIG. 4 shows a schematic of the Hyperspectral Imaging System (HSI) of the present invention, which is consisting of three subsystems: (1) an RC type telescope system; (2) an adapting lens system and (3) an imaging concave grating (ICG) system. The light path of FIG. 4 is (A)->(B)->(C)->(D)-(E)->(F).

FIG. 5 shows the wavelength scattering of a diffraction grating of the present invention.

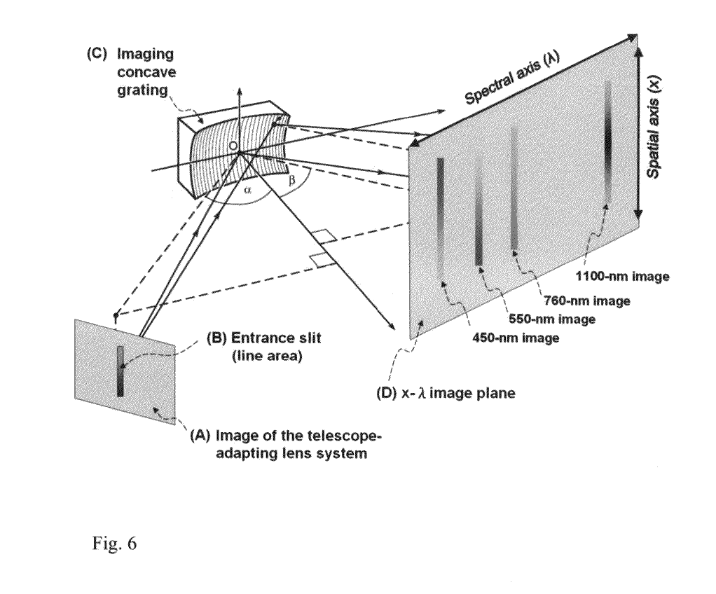

FIG. 6 shows the image formation mechanism of the ICG optical system of the present invention. The ICG disperses and focuses images of different wavelengths on the ICG focal plane (x-λ image plane), which are acquired by a 2D image detector.

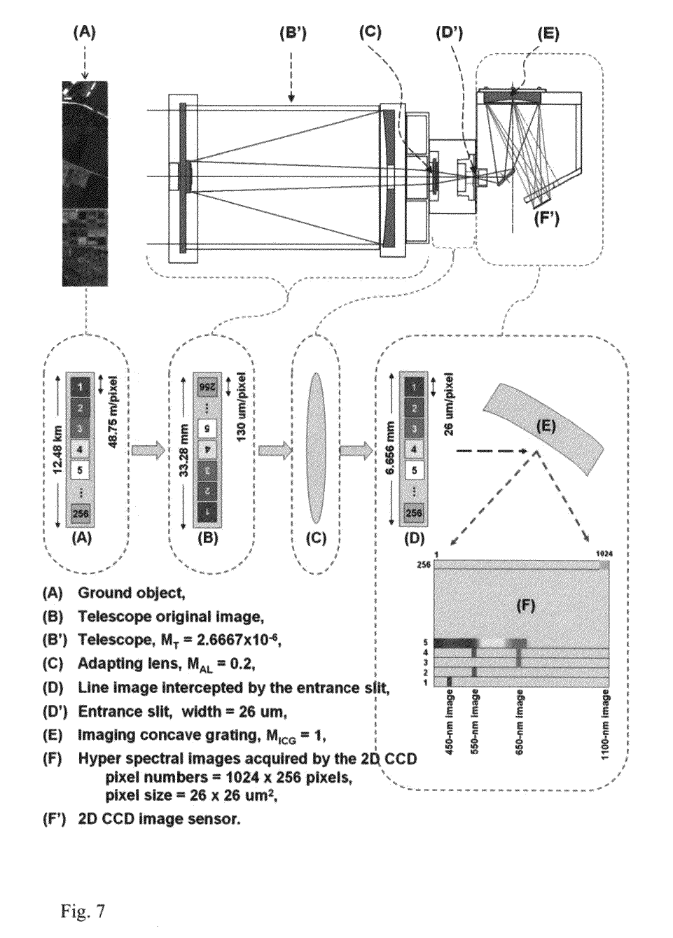

FIG. 7 shows the tracing scheme of the image formation from the CCD image sensor ((F) and (F′)) of the present invention, where the hyperspectral images are acquired, to the ground object (A).

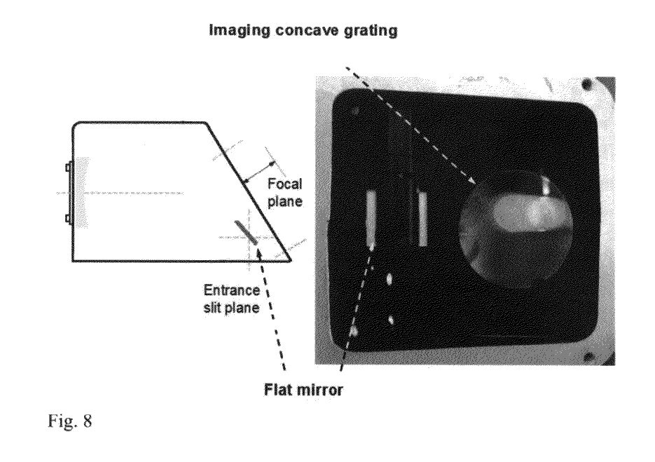

FIG. 8 shows a drawing of the top view of the ICG system of the present invention showing the entrance slit, the flat mirror and the imaging concave grating. Left: Top view drawing of the ICG system. Right: Photo of the interior of the ICG system.

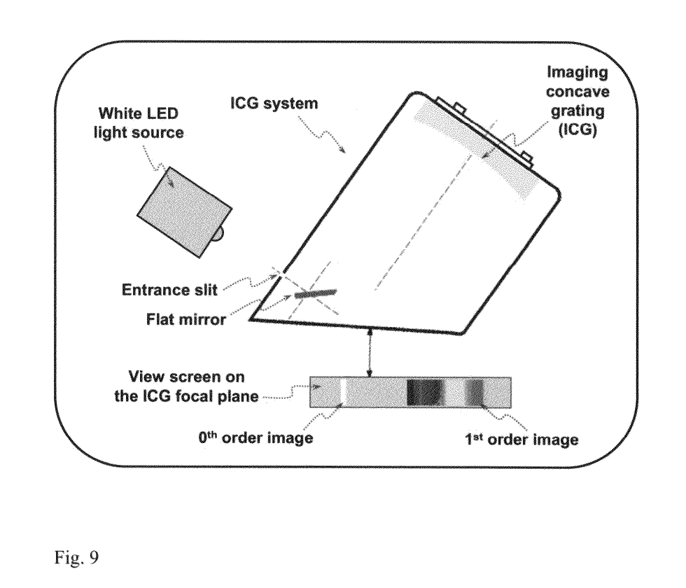

FIG. 9 shows a schematic of the demonstration setup of the ICG system of the present invention.

### EXAMPLES

The examples below are non-limiting and are merely representative of various aspects and features of the present invention.

### Example 1

### Hyperspectral Imaging Optical System Design

The present invention proposed to construct a ground model of a hyperspectral imaging system (HSI) system. The ground model served the purposes of testing the optical and electrical functions and performances of such a system for the determination of the designing parameters in the future construction of a space born model. This HSI system was a precursor for a future space born HSI.

### Example 2

### HSI System Architecture

As shown in FIG. 4, the HSI system was consisting of three subsystems: (1) a RC type telescope system; (2) an adapting lens system and (3) an imaging concave grating (ICG) system. The telescope (A) formed an image on the image plane. In order to match the phase space of the telescope optical system to that of the ICG optical system, an adapting lens system (B) was incorporated in-between the optical output of the telescope (A) and input of the ICG system, i.e., the entrance slit (C). After the entrance slit (C), a flat mirror (D) re-directed the beam to an imaging concave grating (E). The image concave grating generated hyperspectral images on the CCD detector (F).

### Example 3

### Principle of Wavelength Dispersion

FIG. 5 illustrated the physical principle of wavelength dispersion. In the ICG system, the wavelength dispersion was performed by a diffraction grating according to the grating equation, which described the relationship between the dispersed wavelength λ, and the diffracted angle β of λ:

$$\begin{matrix}( sin α + sin β ) = \frac{m λ}{{d}_{0}} & Eq . 4.3 \text{-} ( 01 )\end{matrix} \qquad$$

wherein α was the incident angle, m was the diffraction order and d₀ was the pitch of the diffraction grating.

With a fixed incident angle α and diffraction order m, light wave of different wavelengths were diffracted to different exit direction β according to its wavelength. λ as the following:

$$β = {sin}^{- 1} ( \frac{m λ}{{d}_{0}} - sin α ) \qquad Eq . 4.3 \text{-} ( 02 )$$

### Example 4

### Hyperspectral Imaging Scheme of an ICG Optical System

FIG. 6 described the scheme of the hyperspectral imaging of an ICG system. The telescope-adapting lens system formed an image on the image plane (A). The entrance slit (B) intercepted a line area with the width and the length defined by the entrance slit. The ICG (C) dispersed the incident beams to different exit directions according to their wavelengths (grating equation) and formed images of different wavelengths on the image plane (D). Thus, images of different wavelengths were separated spatially on the image plane (D).

The present invention defined the image plane (D) as the “x-λ image plane” due to its nature of wavelength dispersion in the spectral axis (λ-axis) and line imaging in the spatial axis (x-axis). The images on the x-λ image plane (D) were the so-called “hyperspectral images”. A 2D image detector was usually used to acquire images. For example, supposedly, the line area of the entrance slit carried wavelengths of 450 nm, 550 nm, 760 nm and 1100 nm. The ICG generated separated images on the x-λ image plane (D), each of which corresponded to a different wavelength coming from the line area (B)). As shown in FIG. 3, the 450-nm, 550-nm, 760-nm and 1100-nm images of the linear area (B) were separately focused on the x-λ image plane (D).

### Example 5

### HSI Prototype Design

The overall scheme of image formation was illustrated in FIG. 4. The ground object (A) was imaged by a telescope-adapting lens system ((B′) and (C)) to an image plane where the entrance slit (D′) of the ICG system was located. The HSI system was assumed at an altitude of 600 km above the earth surface. The telescope had a focal length f of 1600 mm and a pupil diameter D of 800 mm as described in the above section. The ICG system was consisting of an entrance slit (D′), an imaging concave grating (E) and a 2D CCD detector (F′).

The following numerical data and calculation are demonstrated as examples for explanation, not for limiting the scope of the present invention.

A 2D CCD (F′) located at the x-λ image plane, i.e., the hyperspectral image focus plane as described in (D) of FIG. 4, acquired the hyperspectral images. The CCD the present invention used had 256 pixels in the vertical direction, i.e., the spatial axis (x-axis), and 1024 pixels in the horizontal direction, i.e., the spectral axis (λ-axis), with a pixel size of 26×26 m². The present invention was able to accomplish the followings:
(1) Trace the image formation from the ground object to the CCD detector at the ICG focal plane and vice versa;
(2) Derive the spatial resolution and the swath width of the HSI telescope system from the pixel size and the sensor size (the pixel number multiples the pixel size) of the image sensor located at the focal plane of the ICG system.

### Example 6

### ICG Dispersion Value

The imaging concave grating had a line density of 230 grooves per mm. The distance from the 400-nm focal point to that of the 1100-nm was 23.29 mm. This gave a dispersion value of 30 nm/mm:

(1100 nm−400 nm)/23.29 mm=30.05581795 nm/mm≈30 nm/mm.

The value of the pixel dispersion was 0.78 nm/pixel:

$$\frac{30.05581795 nm}{1 mm} \times \frac{1 mm}{1000 um} \times \frac{26 um}{1 pixel} = 0.781451266 nm / pixel \approx 0.78 nm / pixel .$$

For example, if a 10-nm spectral bandwidth was required, it took a summation of 13 pixels along the spectral axis to achieve this bandwidth:

10 nm/(0.78 nm/pixel)=12.8 pixels≈13 pixels.

The 2D CCD had 1024 pixels in the spectral axis (horizontal) with a pixel size of 26 m. Thus, the total horizontal length of the CCD detector was 26.624 mm:

1024 pixel×26 m/pixel=26.624 mm.

The CCD length of 26.624 mm was enough to cover the entire range from the 400-nm wavelength to the 1100 nm for the acquisition of the hyperspectral images, which expanded 23.29 mm in the horizontal (spectral) direction on the ICG focal plane.

### Example 7

### Demonstration of ICG Image Formation

The present invention setup an experiment to demonstrate the image formation of the ICG system. On the left hand side of FIG. 8 was a drawing of the top view of the ICG system showing the entrance slit, the flat mirror and the imaging concave grating. On the right of FIG. 8 was a photo of the interior of the ICG system. The imaging concave grating (ICG) and the flat mirror are marked for easy identification.

FIG. 9 illustrated the scheme of the setup for the demonstration. A white LED light source was positioned in front of the entrance slit at a certain distance to illuminate the entrance slit. The illuminated entrance slit acted as an object for the imaging concave grating to form images of dispersed wavelength on the focal plane of the ICG, where a view screen was used for observation.

On the view screen (not shown in the drawings), two images were observed. The white image on the left was the 0^{th} order focused image of the entrance slit and the colorful image on the right was the 1^{st} order hyperspectral image of the entrance slit dispersed horizontally across the view screen.

While the invention has been described and exemplified in sufficient detail for those skilled in this art to make and use it, various alternatives, modifications, and improvements should be apparent without departing from the spirit and scope of the invention.

One skilled in the art readily appreciates that the present invention is well adapted to carry out the objects and obtain the ends and advantages mentioned, as well as those inherent therein. Modifications therein and other uses will occur to those skilled in the art. These modifications are encompassed within the spirit of the invention and are defined by the scope of the claims.

What is claimed is:

1. An image concave grating apparatus comprising:
an entrance slit component for forming a slit light from an input light passing through the entrance slit component according to a width and a length of an entrance slit; and
an image concave grating component for forming a grating spectrum having different wavelengths onto an image plane by scattering the slit light according to a wavelength of the slit light in different directions.

2. An imaging system for simultaneous recording of image and spectrum data of an image from a target comprising:
a light source device for generating a light source image;
a light splitting device for dividing the light source image from the light source device into a first image and a second image;
a first photo sensor device for converting the first image into a first light signal or a spectral signal;
an adapting lens device for regulating a focus of the second image to generating a regulating image;
a second photo sensor device for generating a first electrical spectrum signal or a second light signal comprising
an image concave grating apparatus for forming a grating spectrum having different wavelengths onto an image plane by scattering the regulating image according to a wavelength of the regulating image, and
a second photo sensor device for converting the grating spectrum into a second light signal.

3. The image system of claim 2, further comprising a processor for performing spectral analysis on spectral data generated by the grating spectrum.

4. The image system of claim 3, wherein the processor compares the spectral data with abnormal data of an abnormal target to identify the abnormal target.

5. The image system of claim 3, further comprising a display coupled to the processor, wherein the spectral data is displayed on the display as a spectral image.

6. The imaging system of claim 5, further comprising an imaging channel coupled to an electronic imaging camera generating electronic image data, wherein the electronic image data is displayed as a standard image on the display.

7. The image system of claim 6, wherein the image data and the spectral data of the same light source image are simultaneously displayed on the display.

8. The imaging system of claim 2, wherein the light source device is a Ritchey-Chrétien (RC) telescope.

9. The imaging system of claim 6, wherein the light source device comprises an imaging channel and means for rotating the imaging channel to an input of the imaging channel with respect to an output of the image data and spectral data.

10. The imaging system of claim 2, wherein the light source device is an aerospace telescope for viewing an image or spectrum of an aerospace.

11. The imaging system of claim 2, wherein the first photo sensor device is a CCD sensor, a CMOS sensor, an indium gallium arsenide (InGaAs) sensor, a mercury cadmium telluride (HgCdTe) IR sensor or a lead selenide (PbSe) sensor.

12. The imaging system of claim 2, wherein the first photo sensor device comprises an image concave grating apparatus for forming a grating spectrum having different wavelengths onto an image plane by scattering the regulating image according to a wavelength of the regulating image, and a second photo sensor device for converting the grating spectrum.

13. The imaging system of claim 2, wherein the light source device is a detection device which is a thermal detector.

14. The imaging system of claim 13, wherein the thermal detector detects infrared image or infrared spectrum from the target.

15. The imaging system of claim 11, wherein the CCD sensor is a real-time-image CCD sensor.

16. The imaging system of claim 13, wherein the detection device is an endoscope.

17. The imaging system of claim 13, wherein the detection device is a recorder or camera.

18. The imaging system of claim 2, which is applied to various purposes in forest floor or ocean resources detections including water pollution or chemical waste.

19. The imaging system of claim 2, wherein the first photo sensor device detects from 100 nm to 5000 nm of the light source image.

20. The imaging system of claim 15, wherein the real-time-image CCD sensor identifies high resolution line.

21. The imaging system of claim 2, wherein the light splitting device is at least one mirror.

22. The imaging system of claim 21, wherein the mirror is a flat mirror.

23. The imaging system of claim 2, further comprising a third photo sensor device which comprises a CCD sensor, a CMOS sensor, a indium gallium arsenide (InGaAs) sensor, a mercury cadmium telluride (HgCdTe) IR sensor or a lead selenide (PbSe) sensor for detecting a third image from the light source device.

24. The imaging system of claim 2, wherein the adapting lens device is an adaptor lens.

25. The imaging system of claim 2, wherein the image concave grating apparatus comprising:
an entrance slit component for forming a slit light from an input light passing through the entrance slit component according to a width and a length of an entrance slit; and
an image concave grating component for forming a grating spectrum having different wavelengths onto an image plane by scattering the slit light according to a wavelength of the slit light in different directions.
